(19) United States
(12) Patent Application Publication
(10) Pub. No.: US 2016/0380776 A1
(43) Pub. Date: Dec. 29, 2016

(54) SECURED NEIGHBOR DISCOVERY REGISTRATION UPON DEVICE MOVEMENT

(71) Applicant: Cisco Technology, Inc., San Jose, CA (US)

(72) Inventors: Pascal Thubert, La Colle Sur Loup (FR); Patrick Wetterwald, Mouans Sartoux (FR); Jean-Philippe Vasseur, Saint Martin d'Uriage (FR); Eric Levy-Abegnoli, Valbonne (FR)

(21) Appl. No.: 14/753,373

(22) Filed: Jun. 29, 2015

(51) Int. Cl. H04L 9/32; H04L 29/06

(52) U.S. Cl. CPC H04L 9/3263; H04L 63/126; H04L 2209/24; H04L 2209/64

(57) ABSTRACT

In one embodiment, a device in a network receives a request from a neighbor of the device to add the neighbor as a child of the device in the network. The request includes a signed address registration certificate that certifies that a network address of the neighbor is registered in the network. The device determines whether the signed address registration certificate is valid. The device adds the neighbor as a child of the device in the network based on a determination that the signed address registration certificate is valid.

### TECHNICAL FIELD

The present disclosure relates generally to computer networks, and, more particularly, to secured neighbor discovery (ND) registration upon device movement.

### BACKGROUND

Low power and Lossy Networks (LLNs), e.g., sensor networks, have a myriad of applications, such as Smart Grid and Smart Cities. Various challenges are presented with LLNs, such as lossy links, low bandwidth, battery operation, low memory and/or processing capability of a device, etc. Changing environmental conditions may also affect device communications. For example, physical obstructions (e.g., changes in the foliage density of nearby trees, the opening and closing of doors, etc.), changes in interference (e.g., from other wireless networks or devices), propagation characteristics of the media (e.g., temperature or humidity changes, etc.), and the like, also present unique challenges to LLNs.

The various challenges present in LLNs makes supporting device mobility particularly difficult. Generally speaking, device mobility refers to the ability of a device to move from using one parent node in the network to using another node for purposes of routing traffic. In some cases, for example, the device may physically move to another location, necessitating the parent change. In other cases, a parent change may also be necessitated by other factors, such as changing environmental conditions typical in LLNs (e.g., the current parent of a node becomes unreachable due to an obstruction, etc.), without physical movement of the device. With each parent change by nodes in an LLN, a corresponding request is typically sent to the root/border router of the LLN, to ensure that the address of the moving node is registered to the node and is non-duplicative in the network.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example routing protocol message;

FIG. 4 illustrates an example directed acyclic graph (DAG) in the communication network of FIG. 1;

FIGS. 5A-5G illustrate an example of a device/node joining a network;

FIG. 6 illustrates an example address registration certificate;

FIGS. 7A-7D illustrate an example of a device/node moving within the same network;

FIGS. 8A-8G illustrate an example of a device/node moving across networks;

FIG. 9 illustrates an example simplified procedure for facilitating the migration of a neighbor node;

FIG. 10 illustrates an example simplified procedure for issuing an address registration certificate; and

FIG. 11 illustrates an example simplified procedure for facilitating the migration of a node across networks.

### DESCRIPTION OF EXAMPLE EMBODIMENTS

### Overview

According to one or more embodiments of the disclosure, a device in a network receives a request from a neighbor of the device to add the neighbor as a child of the device in the network. The request includes a signed address registration certificate that certifies that a network address of the neighbor is registered in the network. The device determines whether the signed address registration certificate is valid. The device adds the neighbor as a child of the device in the network based on a determination that the signed address registration certificate is valid.

In further embodiments, a device in a network receives an address registration request for a node attempting to join the network, the request indicating a network address for the node. The device determines whether the network address is already registered in the network. The device issues a signed address registration certificate that certifies that the network address is valid in the network, based on a determination that the network address is not already registered in the network. The device provides the signed address registration certificate to the node.

### Description

A computer network is a geographically distributed collection of nodes is interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth.

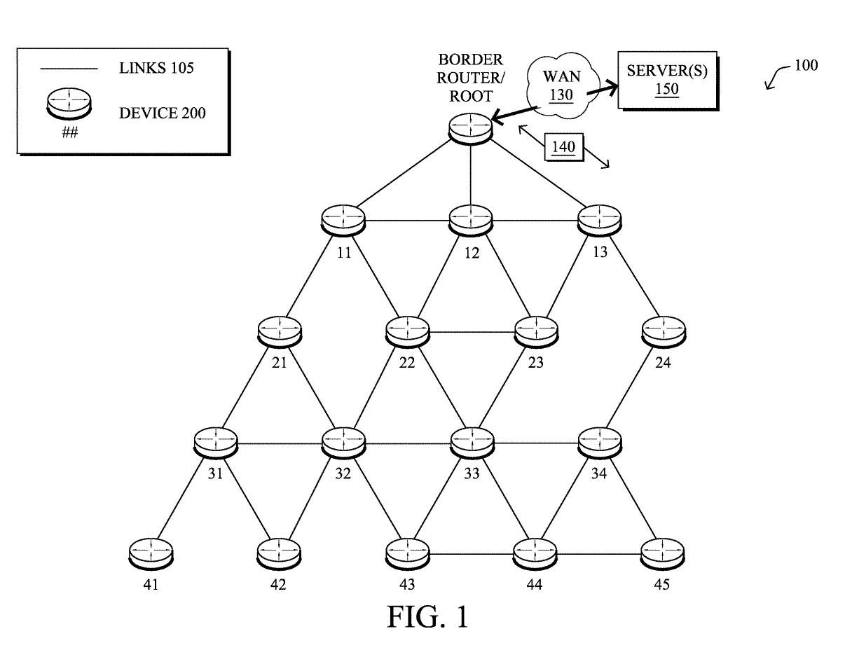

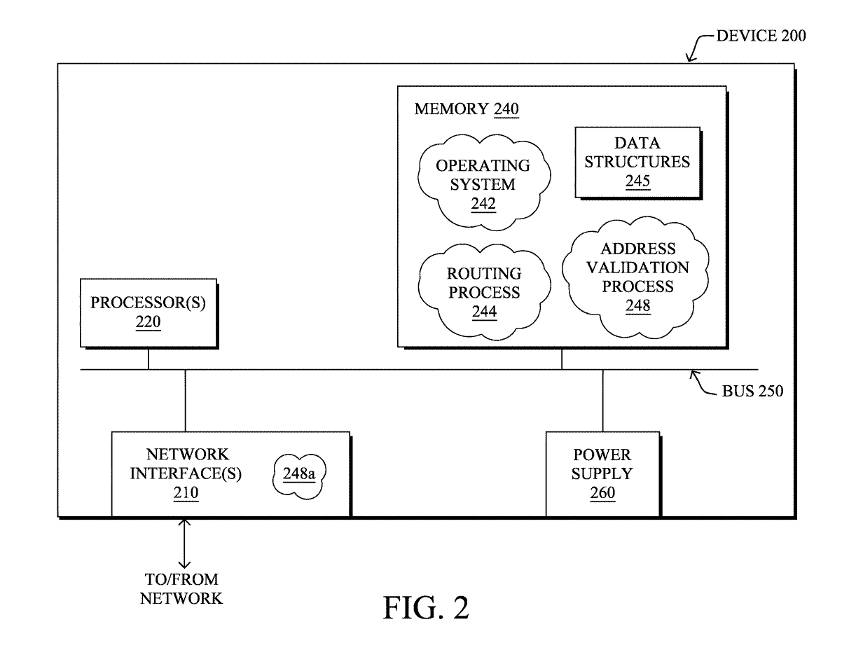

FIG. 1 is a schematic block diagram of an example computer network 100 illustratively comprising nodes/devices 200 (e.g., labeled as shown, a “Border Router/Root,” “11,” “12,” . . . “45,” and described in FIG. 2 below) interconnected by various methods of communication. For instance, the links 105 may be wired links or shared media (e.g., wireless links, PLC links, etc.) where certain nodes 200, such as, e.g., routers, sensors, computers, etc., may be in communication with other nodes 200, e.g., based on distance, signal strength, current operational status, location, etc. The illustrative Border Router/Root node, such as a field area router (FAR) of a FAN, may interconnect the local network with a WAN 130, which may house one or more other relevant devices such as management devices or servers 150, e.g., a network management server (NMS), a dynamic host configuration protocol (DHCP) server, a constrained application protocol (CoAP) server, etc. In some embodiments, network 100 may include a plurality of Border Routers/Root nodes that form a backbone of border routers to which nodes 11-45 etc. may join for routing purposes. Those skilled in the art will understand that any number of nodes, devices, links, etc. may be used in the computer network, and that the view shown herein is for simplicity. Also, those skilled in the art will further understand that while the network is shown in a certain orientation, particularly with a “Border Router/Root” node/device, the network 100 is merely an example illustration that is not meant to limit the disclosure.

Data packets 140 (e.g., traffic and/or messages sent between the devices/nodes) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes shown in FIG. 1 above or described below. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 include the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise routing process/services 244 and/or an illustrative address validation process 248, as described herein. Note that while address validation process 248 is shown in centralized memory 240, alternative embodiments provide for the process to be specifically operated within the network interfaces 210 (process “248a”).

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 includes computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) including, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

In some cases, routing process 244 may support the use of the Internet Protocol version 6 (IPv6) within a wireless personal area network (WPAN), such as those formed is using 802.15.4 wireless links between devices/nodes. For example, routing process 244 may support the IPv6 Over Low Power WPAN (6LoWPAN) Protocol specified in the Internet Engineering Task Force (IETF) Request for Comment (RFC) 6282 entitled, “Compression Format for IPv6 Datagrams over IEEE 802.15.4-Based Networks,” by Hui, et al. (September 2011). The IETF RFC 6775 entitled, “Neighbor Discovery Optimization for IPv6 over Low-Power Wireless Personal Area Networks (6LoWPANs),” by Shelby et al. (November 2012) provides neighbor discovery techniques that routing process 244 may also use to form a 6LoWPAN.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example protocol specified in an IETF Proposed Standard, RFC 6550, entitled “RPL: IPv6 Routing Protocol for Low Power and Lossy Networks” by Winter, et al. (March 2012), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

A DAG is a directed graph having the property that all edges (and/or vertices) are oriented in such a way that no cycles (loops) are supposed to exist. All edges are included in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, in certain embodiments, a sibling of a node within a DAG may be defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, expected transmission count (ETX), etc., while example constraints that may be placed on the route selection may comprise various reliability thresholds, restrictions on battery operation, multipath diversity, bandwidth requirements, transmission types (e.g., wired, wireless, etc.). The OF may provide rules defining the load balancing requirements, such as a number of selected parents (e.g., single parent trees or multi-parent DAGs). Notably, an example for how routing metrics and constraints may be obtained may be found in an IETF RFC, entitled “Routing Metrics used for Path Calculation in Low Power and Lossy Networks” <RFC 6551> by Vasseur, et al. (March 2012 version). Further, an example OF (e.g., a default OF) may be found in an IETF RFC, entitled “RPL Objective Function 0” <RFC 6552> by Thubert (March 2012 version) and “The Minimum Rank Objective Function with Hysteresis” <RFC 6719> by 0. Gnawali et al. (September 2012 version).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going in the opposite direction to the upward messages within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state. In addition, RPL also specifies a message called the DIS (DODAG Information Solicitation) message that is sent under specific circumstances so as to discover DAG neighbors and join a DAG or restore connectivity.

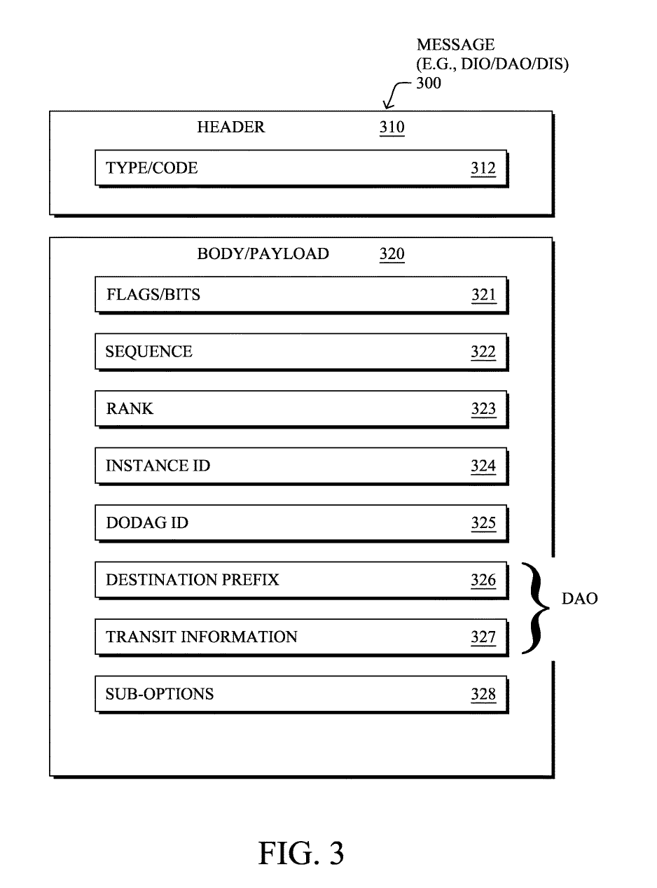

FIG. 3 illustrates an example simplified control message format 300 that may be used for discovery and route dissemination when building a DAG, e.g., as a DIO, DAO, or DIS message. Message 300 illustratively comprises a header 310 with one or more fields 312 that identify the type of message (e.g., a RPL control message), and a specific code indicating the specific type of message, e.g., a DIO, DAO, or DIS. Within the body/payload 320 of the message may be a plurality of fields used to relay the pertinent information. In particular, the fields may comprise various flags/bits 321, a sequence number 322, a rank value 323, an instance ID 324, a DODAG ID 325, and other fields, each as may be appreciated in more detail by those skilled in the art. Further, for DAO messages, additional fields for destination prefixes 326 and a transit information field 327 may also be included, among others (e.g., DAO_Sequence used for ACKs, etc.). For any type of message 300, one or more additional sub-option fields 328 may be used to supply additional or custom information within the message 300. For instance, an objective code point (OCP) sub-option field may be used within a DIO to carry codes specifying a particular objective function (OF) to be used for building the associated DAG. Alternatively, sub-option fields 328 may be used to carry other certain information within a message 300, such as indications, requests, capabilities, lists, notifications, etc., as may be described herein, e.g., in one or more type-length-value (TLV) fields.

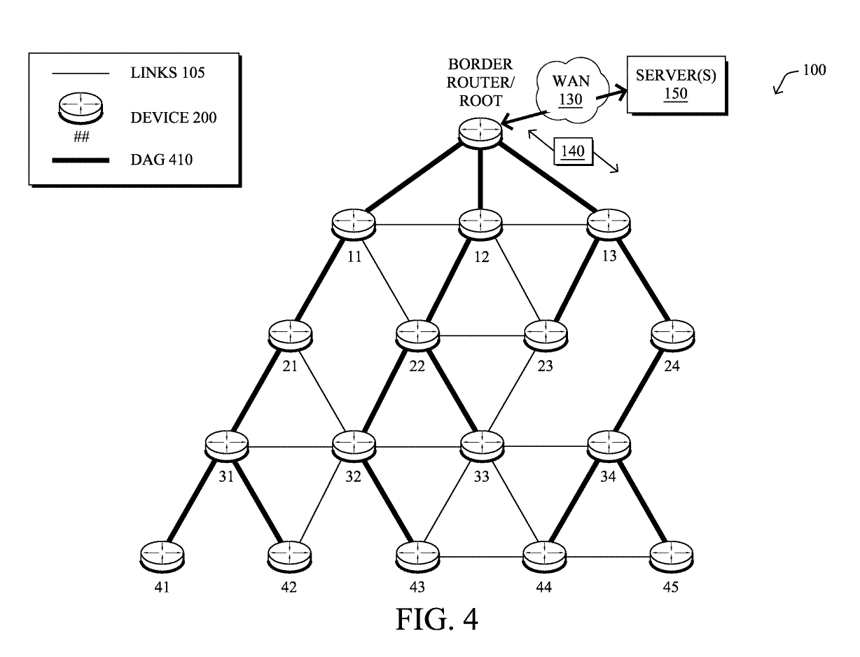

FIG. 4 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 410 (shown as bolded lines), which extends from the root node toward one or more leaf nodes (nodes without children). Traffic/packets 140 (shown in FIG. 1) may then traverse the DAG 410 in either the upward direction toward the root or downward toward the leaf nodes, particularly as described herein.

As noted above, supporting device mobility in mesh networks, such as LLNs, is challenging due to the various constraints on the links and devices in the network. For example, to support device mobility in a 6LoWPAN, RFC 6775 requires that a message exchange occur with the border router with each node movement, to ensure the validity of the address of the moving node. However, such message exchanges may reduce the available resources across the network and negatively affect other traffic flowing in the network.

Secured Neighbor Discovery Registration Upon Device Movement

The techniques herein provide mechanisms to speed up and secure the movement of an LLN node (e.g., a 6LoWPAN node, etc.) to a different parent. In some aspects, a border router or other network device may issue an address registration certificate to the node, indicating that the device will maintain and protect the registered address (e.g., for a granted registration lifetime). This certificate may be used to facilitate both intra-network node movement, as well as intra-network node movement, in various cases.

Specifically, according to one or more embodiments of the disclosure as described in detail below, a device in a network receives a request from a neighbor of the device to add the neighbor as a child of the device in the network. The request includes a signed address registration certificate that certifies that a network address of the neighbor is registered in the network. The device determines whether the signed address registration certificate is valid. The device adds the neighbor as a child of the device in the network based on a determination that the signed address registration certificate is valid.

Illustratively, the techniques described herein may be performed by hardware, software, and/or firmware, such as in accordance with the address validation process 248/248a, which may include computer executable instructions executed by the processor 220 (or independent processor of interfaces 210) to perform functions relating to the techniques described herein, e.g., in conjunction with routing process 244. For example, the techniques herein may be treated as extensions to conventional protocols, such as the various PLC protocols or wireless communication protocols, and as such, may be processed by similar components understood in the art that execute those protocols, accordingly.

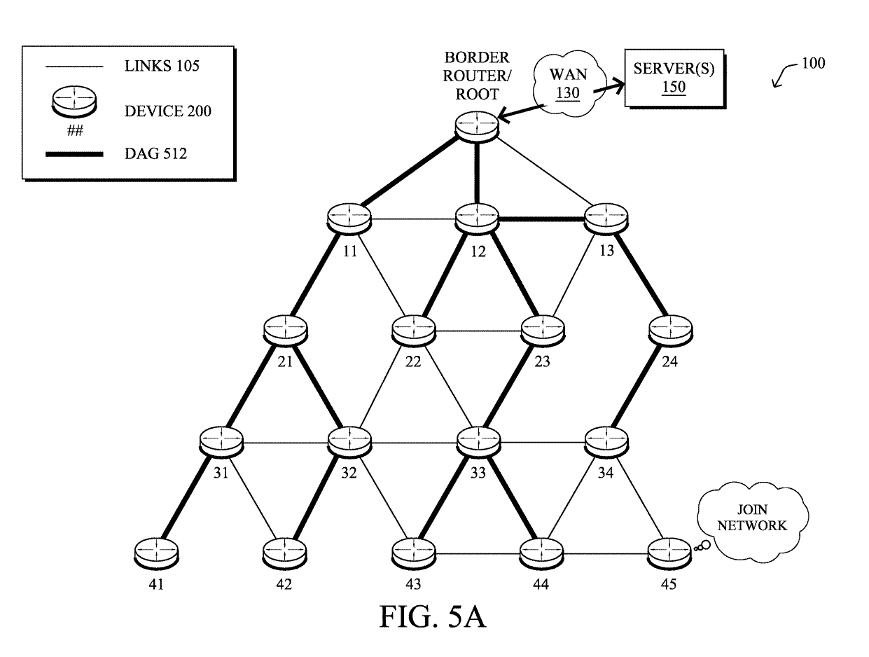

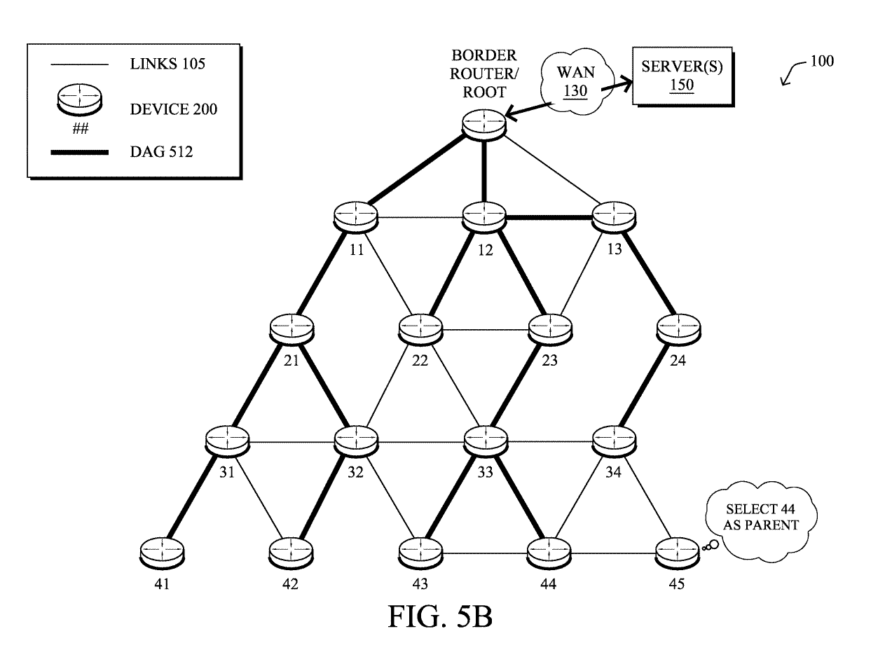

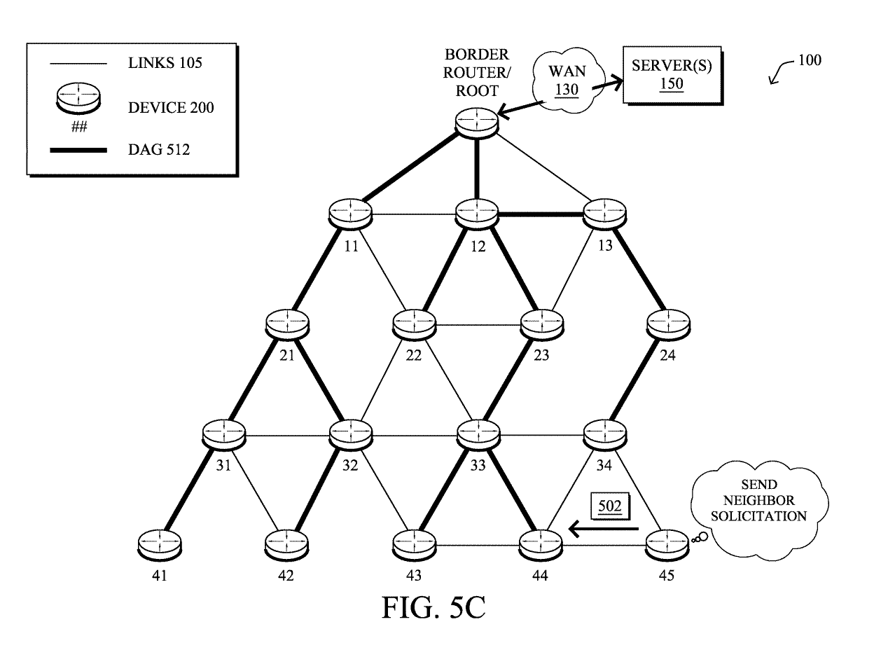

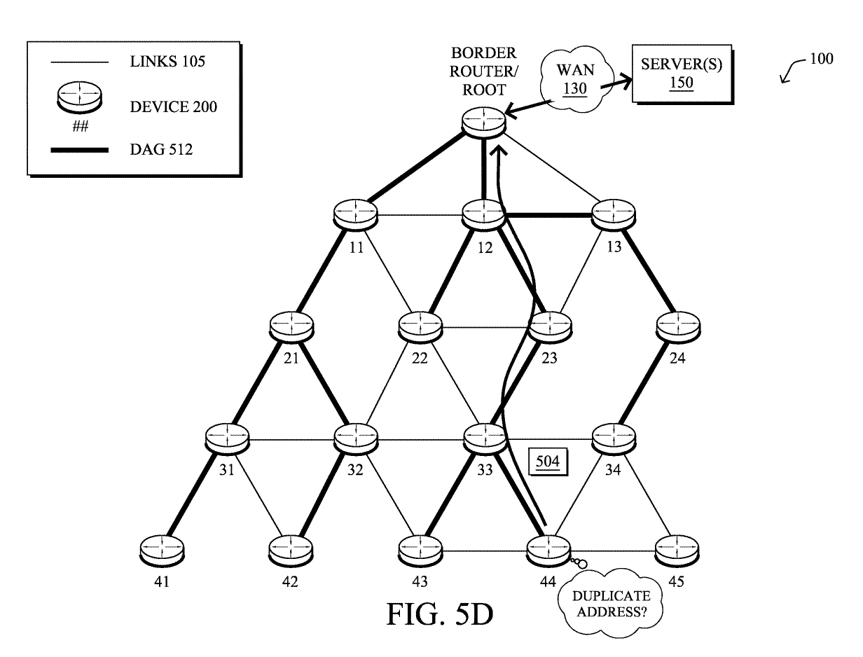

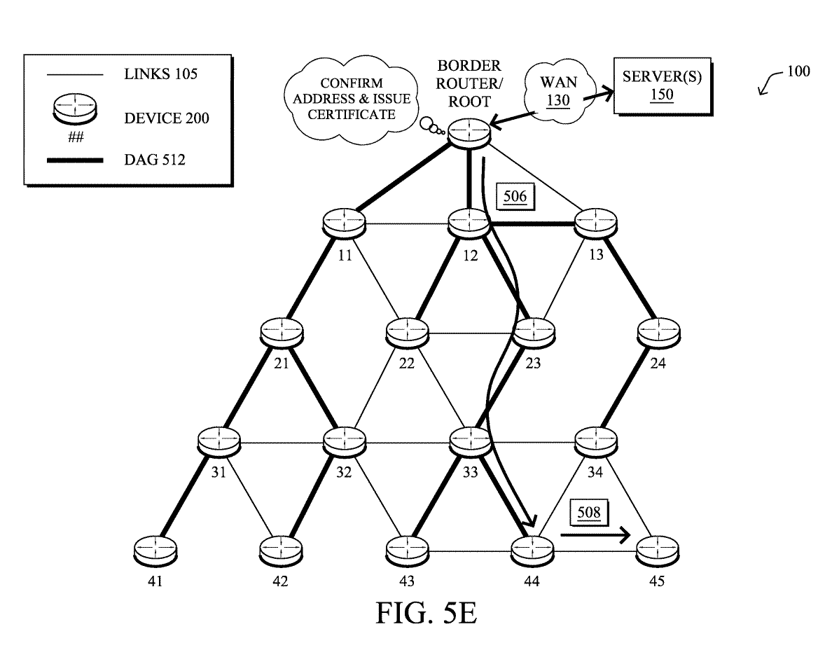

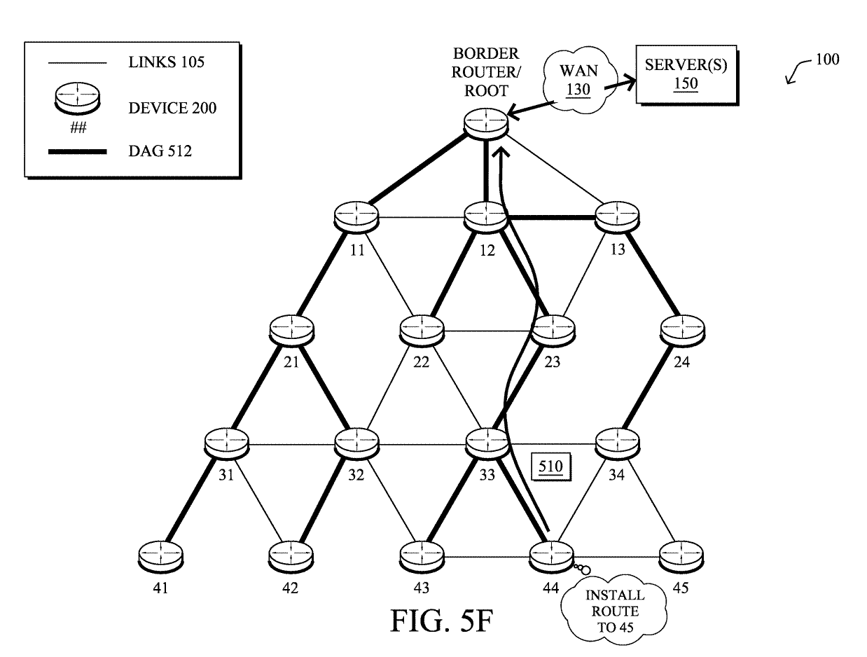

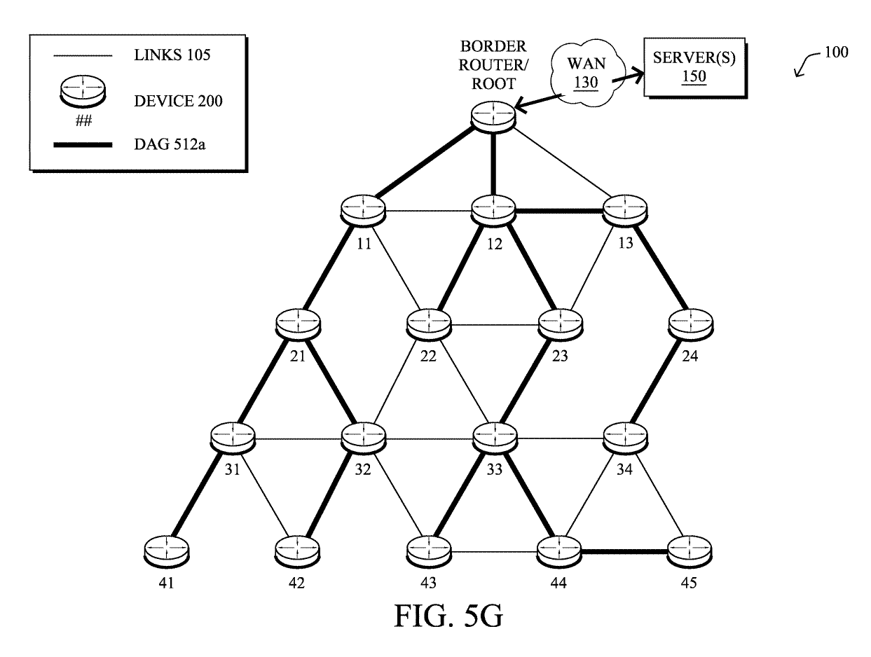

Operationally, an example of a node/device joining a network is shown in FIGS. 5A-5G, according to various embodiments. In some cases, a node joining the network may first select a nearby node/router as its parent. For example, as shown in FIG. 5A, assume that node 45 is not joined to network 100, but is within communication range of both nodes 34 and 44. In such a case, node 45 may determine that node 45 should join network 100, in response to discovering either or both of nodes 34 and 44.

As part of the network join process, a joining node may select a node already in the network to be its parent node. For example, as shown in FIG. 5B, node 45 may select either of nodes 34 and 44 as its parent node within network 100. In some cases, node 45 may base its parent selection on one or more objective functions. For example, node 45 may select node 44 as its parent based on the link quality between nodes 44 and 45 being higher than that of the link between nodes 34 and 45. In other cases, node 45 may select the first node that it discovers in network 100 as its parent.

A joining node may send a neighbor solicitation message to its selected parent, to initiate the network join process. For example, as shown in FIG. 5C, node 45 may send a neighbor solicitation message 502 to its selected parent, node 44. In one embodiment, neighbor solicitation message 502 may be a 6LoWPAN neighbor discovery message. Message 502 may, for example, be used to initiate a number of operations in network 100 such as adding node 45 to network 100, installing one or more routing paths to and/or from node 45, ensuring that the address of node 45 does not already exist in network 100, and/or other such functions.

Duplicate address detection in network 100 may proceed as follows, in some embodiments. First, node 45 may include its address in neighbor solicitation message 502 sent to node 44. For example, neighbor solicitation message 502 may include the address of node 45 in a 6LoWPAN address registration option (ARO). In response to receiving neighbor solicitation message 502, node 44 may attempt to determine whether the address identified by message 502 is already in use within network 100. For example, as shown in FIG. 5D, node 44 may forward the address indicated in message 502 to the Border Router/Root (e.g., a 6LoWPAN Border Router (6LBR)) in a duplicate address request (DAR) message 504.

In response to receiving DAR message 504, the Border Router may determine whether the indicated address of node 45 is already in use within network 100. As shown in FIG. 5E, the Border Router may then send an address confirmation message 506 indicative of the determination back to node 44. For example, address confirmation message 506 may be a 6LoWPAN duplicate address confirmation (DAC) message that indicates whether the address of node 45 is valid or is a duplicate address.

In some embodiments, the Border Router may generate a self-signed address registration certificate that indicates that the address of node 45 is valid and is now registered in network 100, in response to receiving DAR message 504 and validating the address of node 45. In one embodiment, the Border Router may include the signed certificate and/or an associated address registration lifetime in address confirmation message 506 sent back to node 44. Node 44 may then pass the certificate to joining node 45 such as, e.g., in a neighbor solicitation acknowledgement message 508 sent from node 44 to node 45. For example, the address registration certificate may be included in a new ARO option within a 6LoWPAN neighbor advertisement (NA) message, in one embodiment. Node 45 may then use the issued address registration certificate to facilitate its movement to another parent within network 100, without necessitating another DAR/DAC exchange with the Border Router.

In addition to validating the address of node 45, the network join process may entail establishing one or more routing paths between node 45 and the Border Router/Root node. For example, as shown in FIG. 5F, node 44 may send a routing protocol message 510 (e.g., a DAO message) upstream towards the Border Router/Root node, to update DAG 512 to include a routing path from the Root to node 45. In other embodiments, node 45 may itself be enabled to issue routing protocol message 510 (e.g., as opposed to node 44 initiating the routing update), if node 45 also supports the routing protocol (e.g., RPL, etc.). As described in greater detail above, the intermediary devices between node 44 and the Border Router/Root node that receive routing protocol message 510 may set up the route to node 45, thereby leading to the updated DAG 512a shown in FIG. 5G. As shown, DAG 512 has been updated by issuance of routing protocol message 510 to include a routing path from the Border Router/Root node to node 45 that traverses node 44 as the parent of node 45.

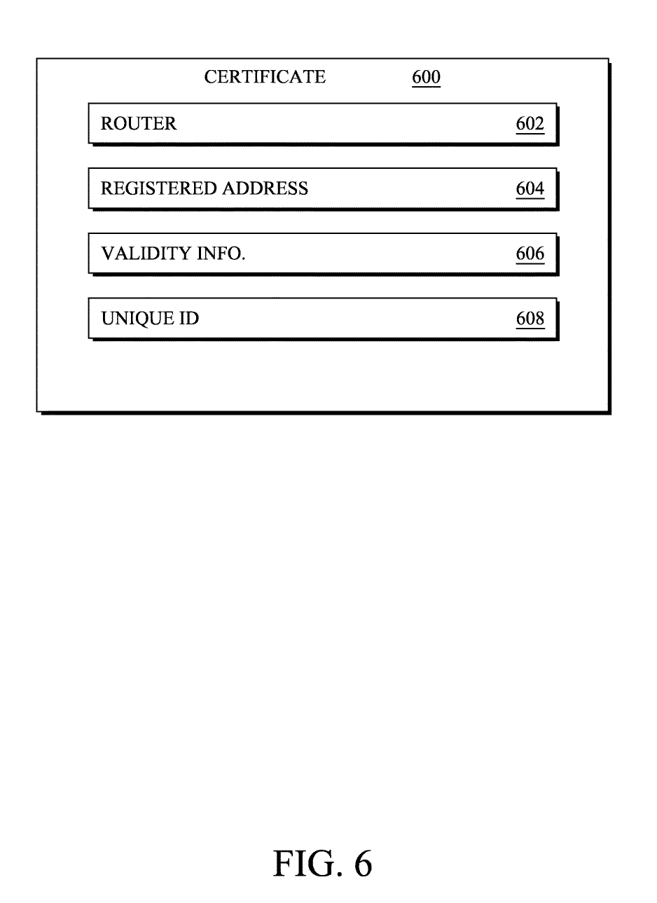

Referring now to FIG. 6, an example address registration certificate is shown, according to various embodiments. As noted above, in response to receiving a new address registration request, a border router (e.g., a 6LBR, etc.) or other device may issue a self-signed certificate 600 that certifies that the address is registered in the network. Certificate 600 may be provided to the joining node in various ways. In one embodiment, certificate 600 may be included in a DAC message sent to the device that generated the registration request (e.g., the intended parent of the joining node, etc.). In turn, the intended parent may pass certificate 600 to the joining node. However, in other embodiments, certificate 600 may be provided directly to the joining node by the border router.

As shown, certificate 600 may indicate any or all of the following:
Router ID 602—an identifier for the border router or other device that issued certificate 600. In one embodiment, Router ID 602 may be the network address of the issuer of certificate 600 (e.g., an IPv6 address, etc.). This address may be used, for example, to facilitate node migrations across networks serviced by different border routers/root nodes.
Registered Address 604—the network address of the node.
Validity Information 606—the time period during which the certificate is valid. Such a time period may correspond to the time period during which the issuer guarantees that address 604 will be protected/assigned to the node.
Unique ID 608—a unique identifier (UID) of the owner of the registration (e.g., the sender of the DAR message. In one embodiment, unique ID 608 may be based on one or more cryptographically generated addresses (CGAs), to validate the ownership of the registration and/or validate certificate 600, itself.

In various embodiments, the issuer of certificate 600 (e.g., the border router, etc.) may sign certificate 600 using a public key infrastructure (PKI) mechanism. For example, the issuing border router may sign certificate 600 using one or more private keys and distribute corresponding encryption keys to one or more of the devices in the network, to allow the other devices to validate the authenticity of certificate 600. In some embodiments, the issuer may employ the use of a certificate authority to issue and sign certificate 600. However, this may also add to the complexity of the system and result in a larger certificate. Further, as would be appreciated, certificate 600 may be issued in response to a node joining the network and/or upon revalidation/reregistration of the address of the node (e.g., after the prior registration period expires).

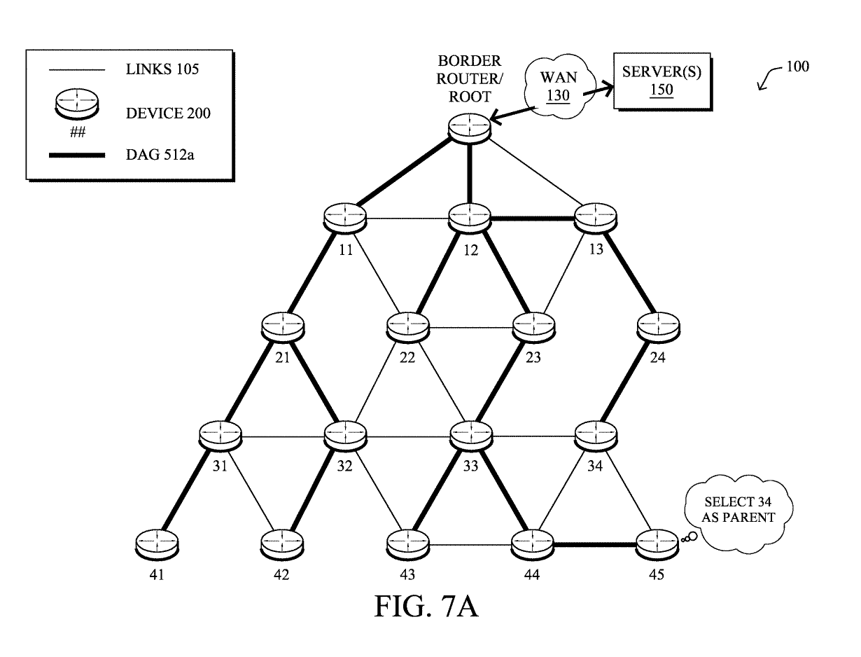

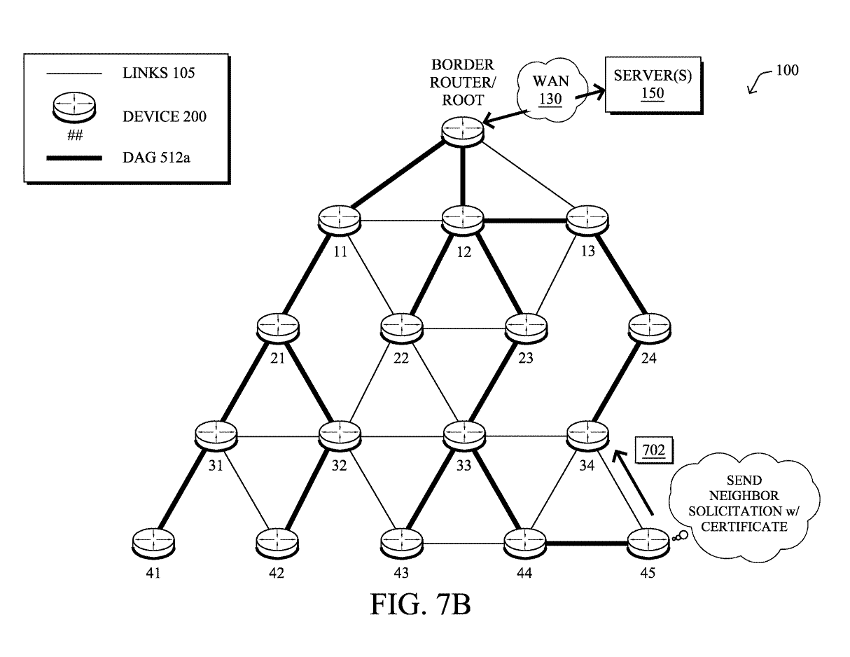

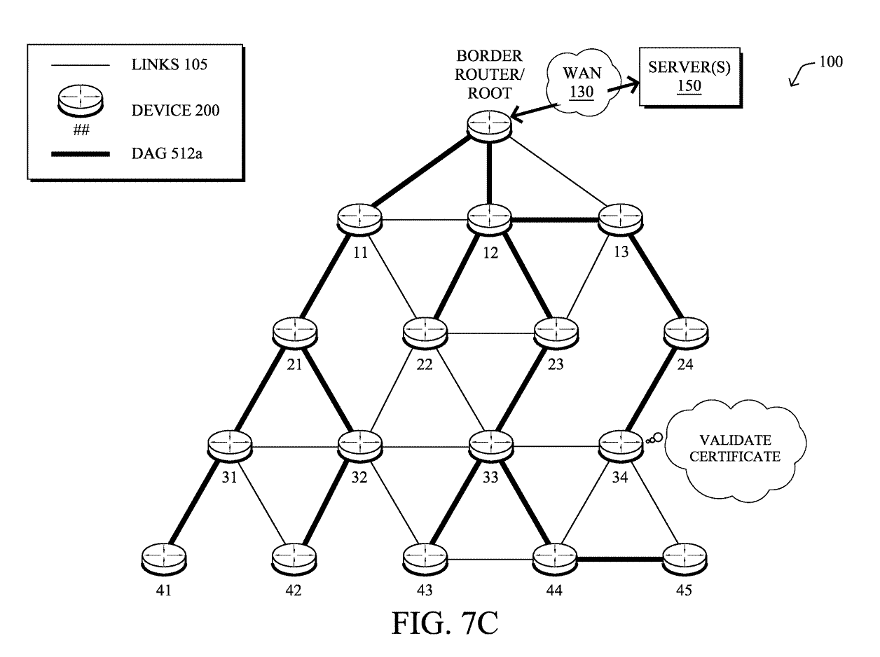

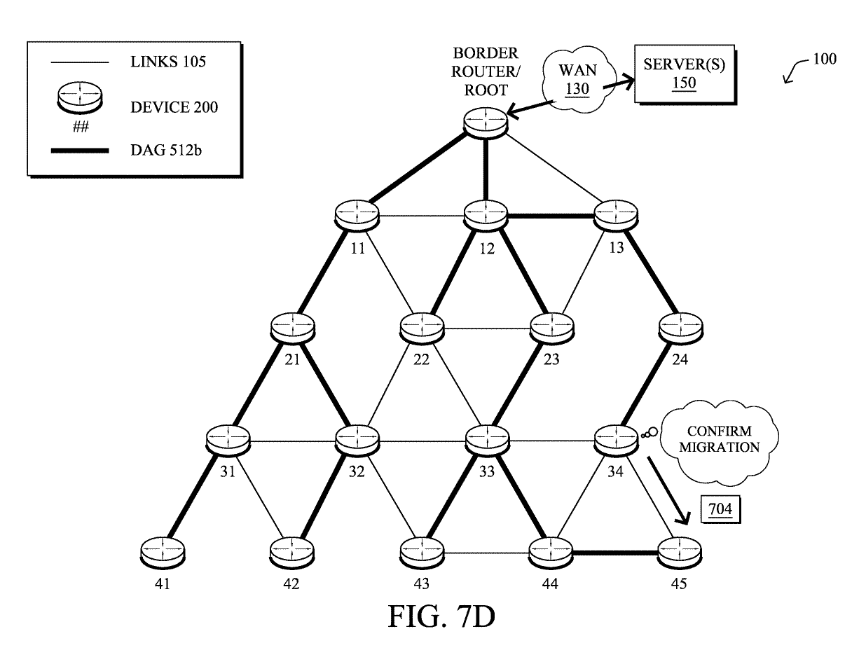

An issued address registration certificate may be used to facilitate: 1.) intra-network moves in which the moving node remains part of the same network, and 2.) inter-network moves in which the moving node joins a network serviced by a different Border Router/Root. An example of an intra-network migration is shown in FIGS. 7A-7D, in various embodiments.

In FIG. 7A, assume that node 45 has joined network 100 using node 44 as its parent in DAG 512a. At some point in time thereafter, node 45 may select a different node as its parent than its current parent, node 44. For example, as shown, node 45 may determine that it should switch parents from node 44 to node 34. In some cases, node 45 may physically move to a different location, thereby necessitating the parent change to node 34. In another example, changing network or environmental conditions may necessitate the parent change to node 34, without node 45 physically moving. For example, node 44 may become unreachable to node 45, the link between node 34 and node 45 may offer better characteristics than that of the link between node 44 and 45 according to an objective function, etc. In other words, in some cases, node 45 may make an intelligent parent selection should node 34 advertise its visible neighbor routers (e.g., via router advertisement messages, etc.).

To initiate the changeover from an existing parent node to a new parent node, a child may send a new neighbor solicitation message to the new parent node. For example, as shown in FIG. 7B, node 45 may initiate the parent change to node 34 by sending a neighbor solicitation message 702 to node 34. In various embodiments, if node 45 was previously issued an address registration certificate, node 45 may include this certificate in message 702 (e.g., via a custom ARO, etc.).

In response to receiving a neighbor solicitation message that includes a signed address registration certificate, the receiving node may determine the validity of the certificate. For example, as shown in FIG. 7C, node 34 may locally validate whether the address registration certificate sent by node 45 is valid. In particular, if the Border Router/Root or other issuer of the certificate previously sent the appropriate keys to node 34, node 34 may determine whether the Border Router/Root in fact signed the certificate. Thus, node 34 may infer the validity of the registered address of node 45 based on the validity of the certificate provided by node 45. In some cases, node 34 may further validate the address based on the validity lifetime indicated by the certificate. In turn, based on the indicated lifetime, node 34 may assert that the Border Router/Root will still defend the registered address for the indicated time period.

In some embodiments, node 34 may further validate the address registration certificate provided by node 45 by ensuring that the certificate was not snooped. For example, in embodiments in which the certificate includes a CGA-based UID, node 34 may further challenge node 45 to prove that it is the actual owner of the CGA.

If node 34 determines that the certificate received from node 45 is valid, node 34 may bypass performing a DAR/DAC exchange with the Border Router/Root, thereby reducing the amount of network traffic that results from the parent change. Instead, by validating the address registration certificate locally, node 34 may accept the validity of the address of node 45 and complete the parent change. For example, node 34 may provide an acknowledgement message 704 (e.g., a 6LoWPAN NA message, etc.) back to node 45 to confirm that node 45 has been added as a child of node 34, as shown in FIG. 7D. Message 704 may, in some embodiments, include the certificate in a custom NA ARO and/or grant node 45 an address registration time that is computed to elapse before the state in the Border Router, and the certificate itself, does. In addition, node 34 may initiate any routing changes necessary (e.g., by issuing a routing protocol message, etc.). As a result, DAG 512a may be updated to form DAG 512b, in which node 45 is now a child of node 34 instead of node 44.

In further embodiments, node 34 may instead validate the address registration certificate of node 45 using another nearby device. Notably, while local address validation by node 34 would result in the least amount of network overhead, using a nearby node to validate the certificate may still result in less overhead than initiating a DAR/DAC exchange with the Border Router/Root. For example, in implementations in which node 34 notifies node 44 of the parent change (e.g., to cause node 44 to initiate a routing change), node 34 may provide the certificate with the notification (e.g., a proxy neighbor solicitation message, etc.), to allow node 44 to perform the address validation instead and provide the results back to node 34.

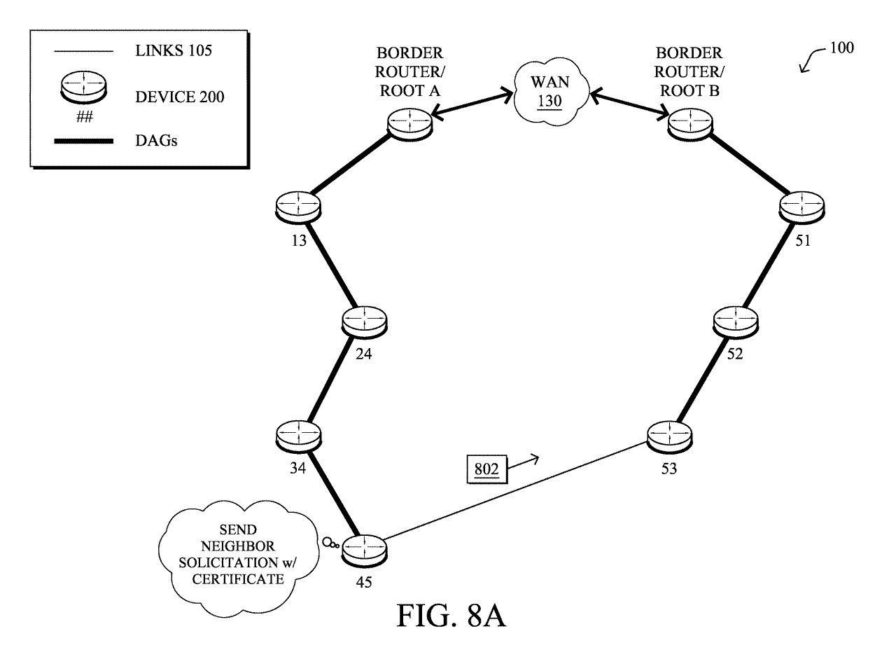

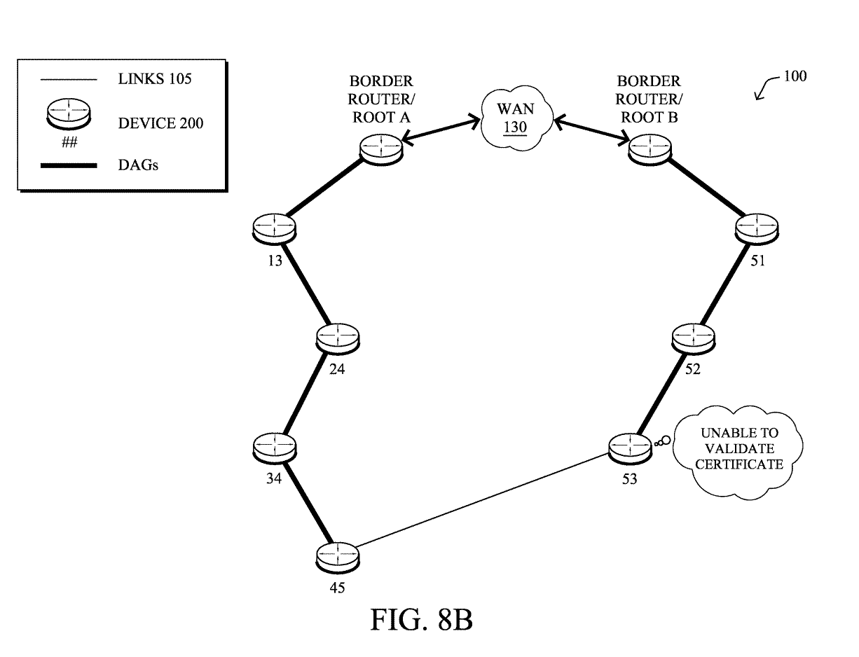

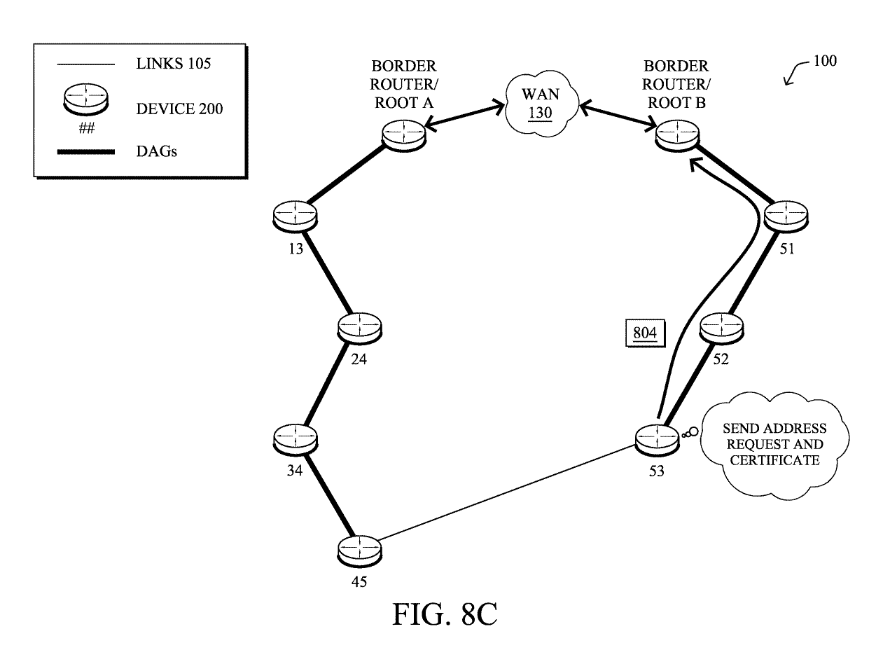

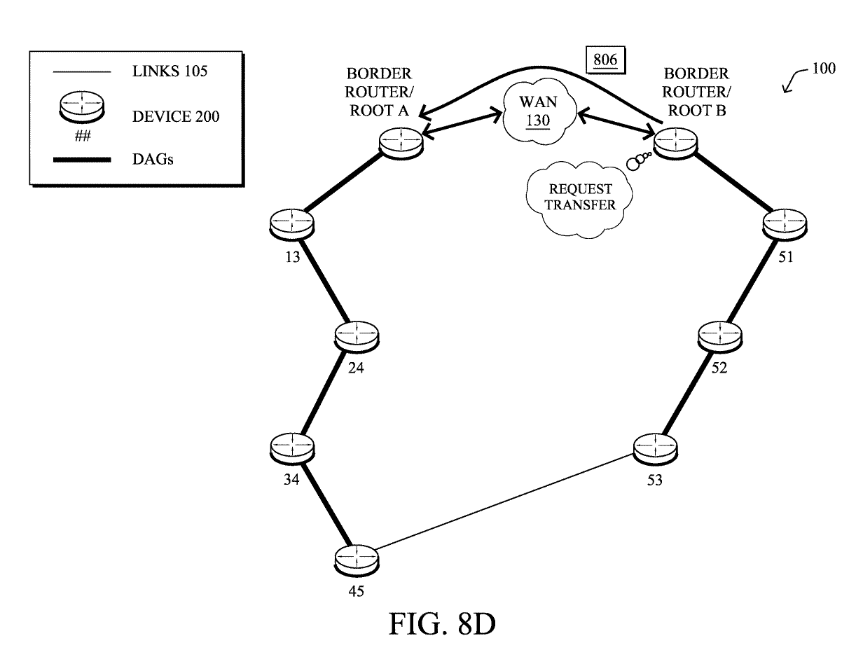

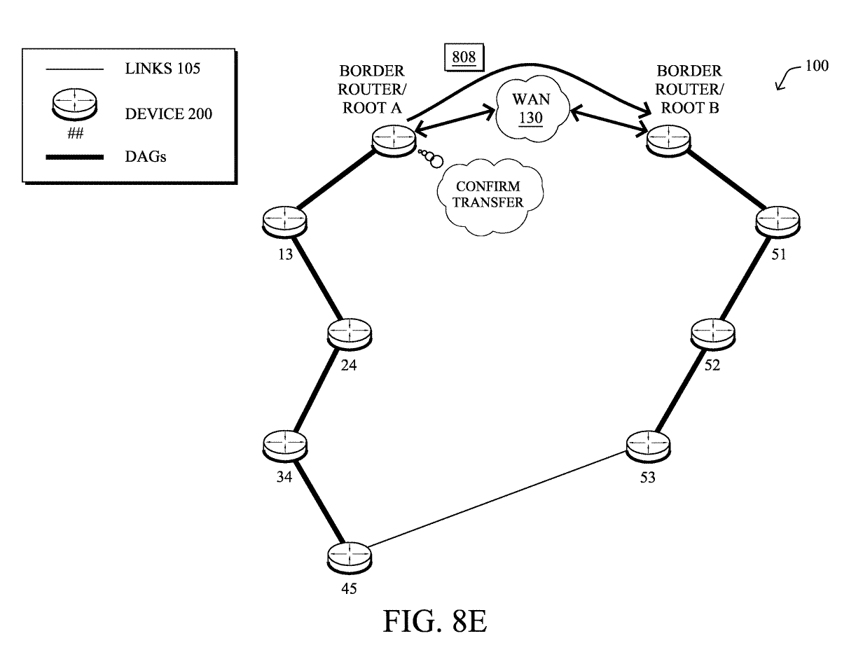

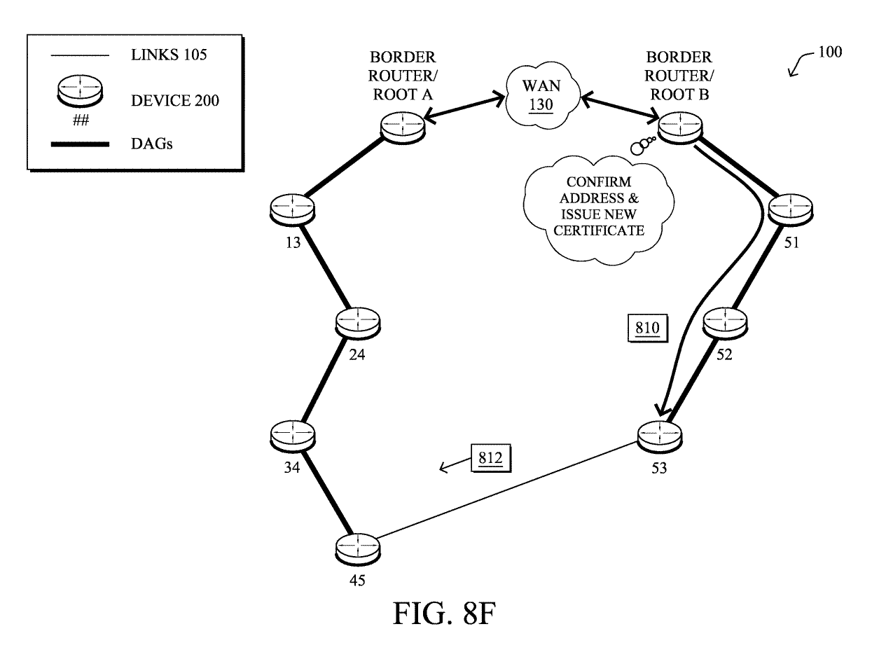

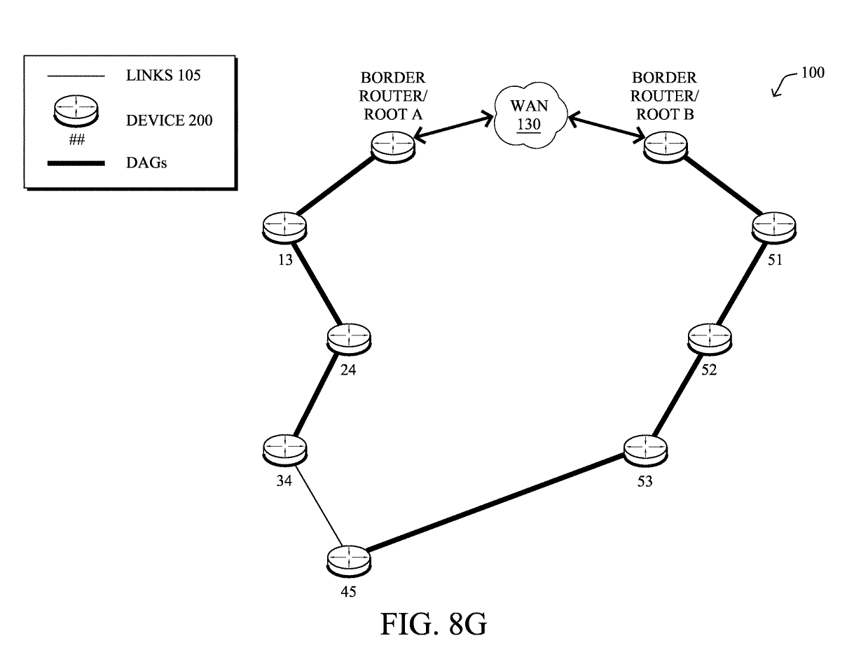

Referring now to FIGS. 8A-8G, an example of a device/node moving across networks is shown, according to various embodiments. As shown in FIG. 8A, assume that node 45 is currently attached to node 34 and is part of a DAG and network serviced by Border Router/Root A. In some cases, a second mesh network serviced by a different border router may neighbor or overlap that of the network to which a given node is attached. For example, assume that node 53 is within proximity to node 45 and that node 53 is attached to a different DAG and network serviced by Border Router/Root B. Thus, node 53 may be an eligible parent for node 45, despite being part of a separate network.

If node 45 selects node 53 as its new parent (e.g., due to changing network conditions, physical node movement, etc.), node 45 may send a neighbor solicitation message 802 to node 53, to initiate the parent change. In one embodiment, node 45 may include its address registration certificate as part of message 802. As detailed above, the included certificate may have been issued and signed by Border Router A, or another device associated with the network serviced by Border Router A, and may certify that the network address of node 45 is valid within the network serviced by Border Router A. In other words, in some embodiments, node 45 may initiate a parent transfer to a different network in a manner similar to initiating a parent transfer within its local network.

As shown in FIG. 8B, node 53 may attempt to validate the address registration certificate received from node 45. In many implementations, node 53 will be unable to validate the certificate sent by node 45, since node 53 will not have the appropriate keys from Border Router A to validate the certificate. In other embodiments, Border Router A may send its keys to nodes in neighboring/overlapping networks, to allow the receiving nodes to validate certificates signed by Border Router A. However, doing so may increase network overhead and require additional resource consumption. If the certificate includes a CGA-based device UID for node 45, node 53 may also ensure that node 45 is indeed the owner of the state associated with the certificate issued by Border Router A.

Regardless of whether node 53 is able to validate the signature of the certificate received from node 45, node 53 will still need to notify its own border router, Border Router B, of the requested addition to the local network. For example, as shown in FIG. 8C, node 53 may send a message 804 (e.g., a DAR message, etc.) to Border Router B. Message 804 may include, for example, the address of node 45, the certificate sent by node 45, and/or any additional information needed by Border Router B to facilitate the migration and to register the address of node 45 with Border Router B. In particular, node 53 may need to notify Border Router B of the migration, so that Border Router B can attract packets destined to node 45 and sent over the backbone network 130 that connects Border Routers A and B.

As shown in FIG. 8D, assume that the border routers connected to backbone network 130 share the appropriate keys to validate certificates issued by them. Thus, in response to receiving the certificate of node 45 in message 804, Border Router B may validate the authenticity of the certificate and identify Border Router A as the issuer of the certificate. In such cases, Border Router B may then send a context transfer request 806 to Border Router A, to initiate the transfer of node 45 to the network serviced by Border Router B. Request 806 may include, for example, information that identifies node 45 and any other information that may be needed to complete the node migration.

In FIG. 8E, Border Router A may perform any number of checks to ensure that the requested node transfer is valid. For example, if node 45 uses a CGA-based UID, Border Router A may perform the necessary checks to ensure that node 45 is indeed the owner of the address. In another example, Border Router A may ensure that the requested migration is more recent than the state in Border Router A for the address registration of node 45. If the transfer is approved, Border Router A may send a transfer response 808 back to Border Router B that indicates the approval, as shown in FIG. 8F. In addition, Border Router A may also begin forwarding any packets destined for node 45 to Border Router B, after approving the node transfer.

Once the transfer has been confirmed, Border Router B may register the address of node 45 and issue a new address registration certificate signed by Border Router B. The issued certificate certifies that the address of node 45 will be protected within the network serviced by Border Router B for the time period indicated. For example, if node 45 later initiates another parent change to another parent in the network serviced by Border Router B, the intended parent may use the appropriate keys from Border Router B, to validate the address without initiating a DAR/DAC exchange with Border Router B. Border Router B may then include the newly issued certificate to node 53, e.g., as part of a DAC message 810.

Once the address of node 45 has been validated, node 53 may include the certificate within a confirmation message 812 sent to node 45 (e.g., in an ARO of a neighbor advertisement message). As shown in FIG. 8G, node 53 may also send one or more routing protocol messages, to update the DAG serviced by Border Router B, to include node 45.

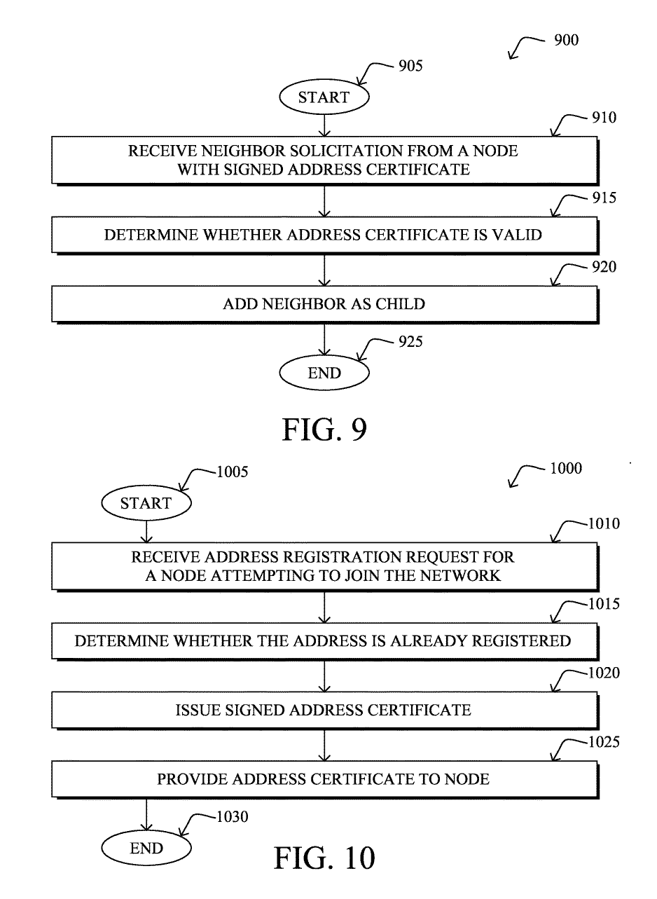

FIG. 9 illustrates an example simplified procedure for facilitating the migration of a neighbor node, according to various embodiments. Procedure 900 may be performed, in some embodiments, by any node/device (e.g., device 200) to which a neighboring node is attempting to migrate. Procedure 900 begins at step 905 and continues on to step 910 where, as described in greater detail above, the device receives a request from the neighbor to add the neighbor as a child of the device. For example, the request may be a 6LoWPAN neighbor solicitation request or any other request that may initiate a parent change in a network. In various embodiments, the request may include a signed address registration certificate that certifies that a network address of the neighbor is registered in the network. In particular, the certificate may be signed by the border router of the network or another supervisory device and may indicate various information such as the identity of the issuer, the network address of the neighbor, a time period during which the address of the neighbor is valid, a UID for the neighbor (e.g., to ensure that the request was not snooped), or any other information that may be used to allow the device to perform validation of the neighbor's address locally.

At step 915, as detailed above, the device may determine whether the signed address registration certificate is valid. To do so, the device may first use encryption keys received from the issuer of the certificate, to verify that the signature of the certificate is valid. In addition, the device may further validate the certificate by ensuring that the received message was not snooped (e.g., by analyzing the CGA-based UID, etc.), by ensuring that the validity time period for the address of the neighbor has not expired, or by performing any other validation operation. If, for example, the device cannot validate the certificate (e.g., the neighbor is not a member of the local network), the device may provide the received certificate to its local border router or another device, to facilitate migration of the neighbor to the local network.

At step 920, the device may add the neighbor as a child of the device, as described in greater detail above. In particular, the device may do so, based on a determination that the address registration certificate received from the neighbor is valid. In turn, the device may send a confirmation message back to the neighbor that confirms the migration. Such a message may indicate, for example, an address registration time period that is based on the validity time period of the certificate. In addition, the device may initiate any routing changes that may be required, to complete the migration of the neighbor. Procedure 900 then ends at step 925.

FIG. 10 illustrates an example simplified procedure for issuing an address registration certificate, according to various embodiments. In general, procedure 1000 may be performed by any device/node (e.g., device/node 200) that is configured to maintain the network addresses registered for use in a network. Procedure 1000 may begin at step 1005 and continue on to step 1010 where, as described in greater detail above, the device may receive an address registration request for a node attempting to join the network. Such a request (e.g., a DAR, etc.) may indicate a network address of the node attempting to join the network.

At step 1015, as detailed above, the device may determine whether the indicated network address in the request has already been registered in the network (e.g., by another node in the network). For example, the device may maintain a listing of the addresses in use within the network, the validity times for these addresses, etc., and compare the network address to this information, to determine whether the network address is already in use.

At step 1020, the device may issue a signed address registration certificate that certifies that the network address is valid, based on a determination that the address was not already in use within the network, as described in greater detail above. In various embodiments, such a certificate may include information such as the identity of the issuing device, the network address of the node joining the network, CGA-based information, and/or a time period during which the address registration is valid. In other words, the device may register the address, if valid, and issue a certificate that certifies the validity of the address.

At step 1025, as detailed above, the device may provide the issued certificate to the node. In some embodiments, the device may provide the certificate to the node indirectly. For example, if the device received the request in step 1010 from an intended parent of the joining node, the device may provide the certificate as part of a response to the request (e.g., as part of a DAC message). In turn, the intended parent may forward the certificate on to the node (e.g., as part of a confirmation message, such as a neighbor advertisement message). In other embodiments, the device may provide the certificate directly back to the joining node. Procedure 1000 then ends at step 1030.

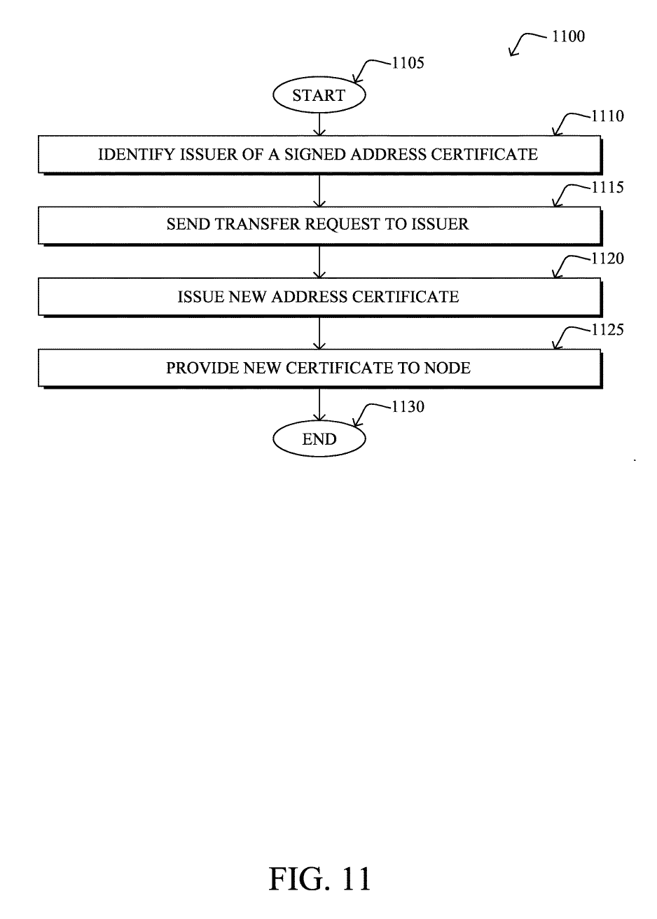

FIG. 11 illustrates an example simplified procedure for facilitating the migration of a node across networks, according to various embodiments. Procedure 1100 may be performed, in some cases, by a device/node (e.g., device/node 200) operable to facilitate an inter-network node migration. Procedure 1100 begins at step 1105 and continues on to step 1110 where, as described in greater detail above, the device may identify an issuer of an address registration certificate. Such a certificate may be received by the device as part of an attempt by a node to migrate to the network associated with the device (e.g., as part of a received DAR message, etc.). In one embodiment, the device may use one or more keys associated with the issuer of the certificate, to validate that the certificate was indeed issued by the issuer. The certificate may also include an indication of the issuer, such as the IPv6 address of the issuer.

At step 1115, as detailed above, the device may send a node transfer request to the issuer of the address registration certificate. For example, assume that the device is a border router of a first network and that the certificate was issued by a border router of another network to which the migrating node was attached. In such a case, the device may request that the other border router transfer the context for the migrating node to the device, to facilitate the migration of the node to the network of the device.

At step 1120, the device may issue a new address registration certificate for the migrating node, as described in greater detail above. In particular, the device may ensure that the address of the migrating node is not a duplicate within the network of the device and, if the address is valid, register the address. In turn, the device may also issue a signed address registration certificate that certifies that the address of the node is registered and valid within the network of the device.

At step 1125, as detailed above, the device may provide the newly issued address registration certificate to the migrating node. In various embodiments, the device may provide the certificate to the node directly or indirectly (e.g., within a DAC message sent to the intended parent of the node). This certificate may then be used, in some embodiments, to facilitate parent transfers of the node within the network, without having to perform a DAR/DAC exchange with the device each time. Procedure 1100 then ends at step 1130.

It should be noted that while certain steps within procedures 900-1100 may be optional as described above, the steps shown in FIGS. 9-11 are merely examples for purposes of illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 900-1100 are described separately, certain steps from each procedure may be incorporated into each other procedure, and the procedures are not meant to be mutually exclusive.

The techniques described herein, therefore, provide for a network node to receive signed proof that its address registration is in effect. This proof can then be used to facilitate migration of the node to a different point of attachment, without requiring a full DAR/DAC exchange over the LLN, which can be very costly to LLN resources.

While there have been shown and described illustrative embodiments that provide for secured neighbor discovery registration upon device movement, it is to be understood that various other adaptations and modifications may be made within the spirit and scope of the embodiments herein. For example, the embodiments have been shown and described herein with relation to certain network configurations. However, the embodiments in their broader sense are not as limited, and may, in fact, be used with other types of computing networks. In addition, while certain protocols are shown, such as RPL, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, at a device in a network, a request from a neighbor of the device to add the neighbor as a child of the device in the network, wherein the request includes a signed address registration certificate that certifies that a network address of the neighbor is registered in the network;
determining, by the device, whether the signed address registration certificate is valid; and
adding, by the device, the neighbor as a child of the device in the network based on a determination that the signed address registration certificate is valid.

2. The method as in claim 1, wherein determining whether the signed address registration certificate is valid comprises:
receiving, at the device, one or more encryption keys from a border router in the network; and
determining, by the device, whether the address registration certificate was signed by the border router using the one or more encryption keys.

3. The method as in claim 1, wherein the signed address registration certificate comprises the network address of the neighbor and comprises an indication of a border router that registered the network address and signed the address registration certificate.

4. The method as in claim 1, wherein the signed address registration certificate comprises an indication of an address lifespan for the network address during which the address is valid, and wherein the device determines whether the address registration certificate is valid based in part on the indicated address lifespan.

5. The method as in claim 1, wherein determining whether the signed address registration certificate is valid further comprises:
determining, by the device, whether the received request was snooped.

6. The method as in claim 1, wherein adding the neighbor as a child of the device comprises:
providing, by the device, a reply message to the neighbor, in response to the request from the neighbor and without the device sending a duplicate address request (DAR) to a border router of the network for the network address of the neighbor.

7. The method as in claim 1, further comprising:
receiving, at the device, a request from a second neighbor of the device to add the neighbor as a child of the device in the network, wherein the request includes a second signed address registration certificate;
determining, by the device, that the device is unable to validate the second signed address registration certificate; and
forwarding, by the device, the second signed address registration certificate to a border router of the network.

8. A method comprising:
receiving, at a device in a network, an address registration request for a node attempting to join the network, wherein the request indicates a network address for the node;
determining, by the device, whether the network address is already registered in the network;
issuing, by the device, a signed address registration certificate that certifies that the network address is valid in the network, based on a determination that the network address is not already registered in the network; and
providing, by the device, the signed address registration certificate to the node.

9. The method as in claim 8, wherein the signed address registration certificate comprises the network address of the neighbor and comprises an indication of a border router that registered the network address and signed the address registration certificate.

10. The method as in claim 8, further comprising:
providing, by the device, one or more encryption keys to a neighbor of the node in the network to validate the signed address registration certificate.

11. The method as in claim 8, further comprising:
identifying, by the device, an issuer of a second address registration certificate issued to a second node attempting to join the network;
sending, by the device, a network transfer request to the issuer, to initiate migration of the second node to the network;
issuing, by the device, a new address registration certificate for the second node, wherein the new address registration certificate certifies that a network address associated with the second node is registered in the network; and
providing, by the device, the new address registration certificate to the second node.

12. The method as in claim 11, further comprising:
receiving, at the device, the second address registration certificate, in response to a neighbor of the second node being unable to validate the second address registration certificate when attempting to add the second node to the network.

13. An apparatus, comprising:
one or more network interfaces to communicate with a network;
a processor coupled to the network interfaces and configured to execute one or more processes; and
a memory configured to store a process executable by the processor, the process when executed operable to:
receive a request from a neighbor of the apparatus to add the neighbor as a child of the device in the network, wherein the request includes a signed address registration certificate that certifies that a network address of the neighbor is registered in the network;
determine whether the signed address registration certificate is valid; and
add the neighbor as a child of the device in the network based on a determination that the signed address registration certificate is valid.

14. The apparatus as in claim 13, wherein the apparatus determines whether the signed address registration certificate valid by:
receiving one or more encryption keys from a border router in the network; and
determine whether the address registration certificate was signed by the border router using the one or more encryption keys.

15. The apparatus as in claim 13, wherein the signed address registration certificate comprises the network address of the neighbor and comprises an indication of a border router that registered the network address and signed the address registration certificate.

16. The apparatus as in claim 13, wherein the signed address registration certificate comprises an indication of an address lifespan for the network address during which the address is valid, and wherein the apparatus determines whether the address registration certificate is valid based in part on the indicated address lifespan.

17. The apparatus as in claim 13, wherein the apparatus adds the neighbor as a child of the apparatus by:
providing a reply message to the neighbor, in response to the request from the neighbor and without the apparatus sending a duplicate address request (DAR) to a border router of the network for the network address of the neighbor.

18. The apparatus as in claim 13, wherein the process when executed is further operable to:
receive a request from a second neighbor of the apparatus to add the neighbor as a child of the apparatus in the network, wherein the request includes a second signed address registration certificate;
determine that the apparatus is unable to validate the second signed address registration certificate; and
forward the second signed address registration certificate to a border router of the network.

19. An apparatus, comprising:
one or more network interfaces to communicate with a network;
a processor coupled to the network interfaces and configured to execute one or more processes; and
a memory configured to store a process executable by the processor, the process when executed operable to:
receive an address registration request for a node attempting to join the network, wherein the request indicates a network address for the node;
determine whether the network address is already registered in the network;
issue a signed address registration certificate that certifies that the network address is valid in the network, based on a determination that the network address is not already registered in the network; and
provide the signed address registration certificate to the node.

20. The apparatus as in claim 19, wherein the process when executed is further operable to:
provide one or more encryption keys to a neighbor of the node in the network to validate the signed address registration certificate.

21. The apparatus as in claim 19, wherein the process when executed is further operable to:
identify an issuer of a second address registration certificate issued to a second node attempting to join the network;
send a network transfer request to the issuer, to initiate migration of the second node to the network;
issue a new address registration certificate for the second node, wherein the new address registration certificate certifies that a network address associated with the second node is registered in the network; and
provide the new address registration certificate to the second node.

22. The apparatus as in claim 21, wherein the process when executed is further operable to:
receive the second address registration certificate, in response to a neighbor of the second node being unable to validate the second address registration certificate when attempting to add the second node to the network.
